(19) United States
(12) Patent Application Publication
(10) Pub. No.: US 2012/0080556 A1
(43) Pub. Date: Apr. 5, 2012

(54) Systems and Methods for Autonomous Operations of Unmanned Aerial Vehicles

(75) Inventor: George Raymond Root, JR., Gambrills, MD (US)

(73) Assignee: LOCKHEED MARTIN CORPORATION, Bethesda, MD (US)

(21) Appl. No.: 12/897,926

(22) Filed: Oct. 5, 2010

(51) Int. Cl. B64F 1/04; B65D 88/00; G01W 1/00; B64F 1/02

(52) U.S. Cl. 244/63; 244/110 F; 220/1.5; 73/170.28

(57) ABSTRACT

Systems and methods are disclosed for autonomous or remote-controlled operation of unmanned aerial vehicles (“UAVs”). An integrated mechanical and electrical system is capable of launching, controlling, snagging, recovering, securing, parking, and servicing UAVs without human intervention at the site of the system. The illustrative embodiment comprises a boom and a container that houses the boom and UAV(s). The boom rotates about its longitudinal axis to operationally orient a plurality of faces thereof. Each face is associated with certain system operations, including but not limited to: launching a UAV, snagging a UAV from the air, and securing a UAV to the boom.

### FIELD OF THE INVENTION

The present invention relates to unmanned aerial vehicles in general, and, more particularly, to autonomous operations of unmanned aerial vehicles.

### BACKGROUND OF THE INVENTION

Unmanned aerial vehicles (“UAVs”) are now widely used for reconnaissance and attack missions. Typically, UAVs are small, relatively inexpensive, and, of course, uncrewed. Though traditionally simple drones, newer UAVs are capable of autonomous or semi-autonomous operation. But this increased sophistication brings with it mobility and maintainability issues.

Current operations for small UAVs require intensive human support that frequently includes active intervention and handling between operations (e.g., preflight testing, launch, recovery, fueling, maintenance between airborne missions, etc.). Human intervention is costly, potentially risky, and can limit the utility of UAV operations. Furthermore, the infrastructure associated with launching, recovering, and servicing UAVs can be extensive.

### SUMMARY OF THE INVENTION

The present invention provides an integrated mechanical and electrical system and methods for autonomously or remotely controlling the launch, recovery, and servicing of UAVs. Some embodiments enable wholly autonomous operation of the system; others enable operations, at least in part, under remote control. The system is hereinafter referenced as the “Autonomous UAV Operations System” or “AUOS.”

The illustrative embodiment of the AUOS comprises a container having the appearance of a twenty-foot intermodal container and a boom. The container, which is (or emulates) an industry-standard shipping container, houses the boom and one or more UAVs. The boom is supported within the container such that it possesses two degrees of rotational freedom. This is unique among booms used for this purpose.

One of the rotational degrees-of-freedom enables the boom to deploy from the container to launch or recover a UAV. In the illustrative embodiment, this is accomplished by pivotably coupling one end of the boom to the interior of the container (or to elements within the container), such that the other end of the boom is able to swing in and out of the container by pivoting about the coupled end.

The boom is multi-functional; it provides at least UAV launch and recovery capabilities. In accordance with the illustrative embodiment, and unlike the prior art (see, e.g., U.S. Pat. Nos. 7,510,145 B2 and 7,219,856 B2, etc.), this multi-functionality is implemented by providing the boom with a plurality of “faces,” each of which is associated with a certain operation of the system, i.e., launching a UAV, snagging a UAV from the air, and securing a UAV to the boom. The boom is rotatable about its longitudinal axis—the second rotational degree-of-freedom—so that a particular face can be rotated into an operational orientation as required. In contrast, in most prior-art systems, the boom does not rotate about its longitudinal axis and typically serves as a rigid support to snag a UAV from the air.

In the illustrative embodiment, the boom has three faces, giving the boom a triangular cross-section. One of the three faces is associated with UAV launch operations, a second face is associated with UAV recovery operations, and a third of the faces is associated with securing a recovered UAV. Each face is correspondingly equipped and physically adapted to conduct the associated operation(s), as described further in the Detailed Description section below.

In addition to storing the boom, the container provides storage for one or more UAVs that are to be used with the AUOS. For that purpose, the container includes parking bays for securely stowing the UAVs until use and also provides infrastructure for servicing the UAVs while in the parking bays.

Since the AUOS is intended, in some embodiments, to operate autonomously and/or via remote control, the container also includes weather-sensing equipment and communications equipment.

The AUOS has several advantages in comparison to the prior art. One advantage is its portability. In its containerized form, the entire AUOS and supported UAVs can be stored, transported, and deployed with relative convenience. As such, an existing platform, such as a ship or a fixed location, need not be pre-equipped for UAV operations. It is notable, however, that the boom is capable of operating absent the container, for example on a ship or a static structure.

A further advantage of the AUOS is camouflage. In particular, in some embodiments, the container is (or has the appearance of) a twenty- or forty-foot intermodal container of the kind that is well-known in the art and commercially available as a standard shipping container. Camouflaged in such fashion, the AUOS might remain unrecognized by a reconnaissance drone, etc. This enhances the survivability of the AUOS.

Some systems for launching and recovering an unmanned aerial vehicle according to the present invention comprise: a boom having a first end and a second end, wherein: the boom comprises a plurality of faces, each face being disposed parallel to a longitudinal axis of the boom, and the boom is operable to rotate about the longitudinal axis thereof to orient each face to an operational orientation in accordance with a corresponding operation of the boom, and wherein the operation comprises at least one of launching, snagging, and securing the unmanned aerial vehicle.

Some methods for use with an unmanned aerial vehicle comprise: pivoting a boom about a first end thereof, causing the boom to move between a stowed position and a deployed position, wherein in the deployed position, the boom performs at least two operations related to the unmanned aerial vehicle; partially rotating the boom about a longitudinal axis thereof to move one face of a plurality of faces of the boom to an operational orientation, wherein one operation of the at least two operations is performed when the one face is in the operational orientation; and conducting the one operation.

### BRIEF DESCRIPTION OF THE DRAWINGS

FIG. 1 depicts an exterior view of AUOS 100 in accordance with some embodiments of the present invention.

FIG. 2 depicts a ghosted view of AUOS 100 and three unmanned aerial vehicles in accordance with some embodiments of the present invention.

FIG. 3 depicts a view of container 102 of AUOS 100, wherein communications and weather-sensing devices are deployed from the container via hatchways and a UAV rests on boom 222.

FIG. 4 depicts a view of boom 222 of AUOS 100, wherein the boom is in a pre-launch position.

FIG. 5 depicts boom 222 launching a UAV.

FIG. 6 depicts a view of a UAV in the air with a hook deployed for recovery.

FIG. 7 depicts boom 222 in a recovery position with a recovery cable deployed.

FIG. 8 depicts the recovery cable snagging the UAV of FIG. 6 from the air.

FIG. 9 depicts the snagged UAV of FIG. 8 hanging from the recovery cable.

FIG. 10 depicts boom 222 rotating from a snagging position to a securing position.

FIG. 11 depicts boom 222 fully rotated to the securing position and the UAV secured to the appropriate face of the boom.

FIG. 12 depicts a method in accordance with the illustrative embodiment of the present invention.

FIG. 13A depicts UAV launch sub-operations of the method of FIG. 12.

FIG. 13B depicts UAV recovery sub-operations of the method of FIG. 12.

FIG. 13C depicts UAV securing sub-operations of the method of FIG. 12.

FIG. 13D depicts UAV parking sub-operations of the method of FIG. 12.

### DETAILED DESCRIPTION

The following terms are defined for use in this disclosure and in the accompanying claims:
The term “intermodal container” or “freight container” or “shipping container” is well-known in the art as a transport and storage box commonly used in shipping, whether by ship, train, truck, or another mode of transportation. See, e.g., Wikipedia online, Intermodal container, http://en.wikipedia.org/wiki/Intermodal_container (last visited Sep. 1, 2010). Intermodal containers are dimensioned in industry-standard measurements that differ slightly among manufacturers, but which nevertheless are understood to be of “standard” sizes.
The term “operatively coupled” means that the operation of one element or device affects another device, wherein the devices need not be physically coupled. For example, a laser and a mirror are operatively coupled if a laser directs a beam of light to the mirror.
The term “physically connected” or “physically coupled” means in direct physical contact and affixed (e.g., a mirror that is mounted on a linear-motor).
The term “twenty-foot equivalent unit” or “TEU” is an inexact unit of cargo capacity that is well-known in the art to describe the cargo capacity of an intermodal (or freight) container of “twenty-foot” length. See, e.g., Wikipedia online, Twenty-foot equivalent unit, http://en.wikipedia.org/wiki/Twenty-foot_equivalent_unit (last visited Sep. 1, 2010). One TEU is defined as the cargo capacity of one twenty-foot intermodal container. Ibid. Although the term TEU sometimes refers in the art to the container itself, for purposes of this disclosure, TEU will be left to represent a measure of capacity.
The term “twenty-foot intermodal container” or “TIC” refers, for the purposes of this disclosure, to an intermodal container of a length of twenty imperial feet, as it is understood in the art to be an industry standard that approximates 20 imperial feet in length, 8 imperial feet in width, and 8.5 imperial feet in height, but it is further known in the art that exact measurements differ by manufacturer. See, e.g., CargoWiz by Softtruck, Advertised Sea Container Dimensions (also called intermodal containers) Interior Dimensions, http://www.softtruck.com/Container_Dimensions.htm (last visited Sep. 1, 2010); Wikipedia online, Twenty-foot equivalent unit, http://en.wikipedia.orq/wiki/Twenty-foot_equivalent_unit (last visited Sep. 1, 2010); Wikipedia online, Intermodal container, http://en.wikipedia.org/wiki/Intermodal_container (last visited Sep. 1, 2010). In metric units, an exemplary twenty-foot intermodal container measures 5.906 meters in length, 2.350 meters in width, and 2.393 meters in height, with a cargo volume of 33.2 cubic meters. CargoWiz by Softtruck, Advertised Sea Container Dimensions (also called intermodal containers) Interior Dimensions, http://www.softtruck.com/Container_Dimensions.htm (citing the dimensions of an “APC Maersk 20′ Standard” container) (last visited Sep. 1, 2010).
   Additional terms are defined elsewhere in the Description in context.

The illustrative embodiment of the present invention is a system that comprises a boom and a container having the appearance of a twenty-foot intermodal container. In the illustrative embodiment, the system supports three UAVs. But the invention is not so limited; as described in further detail below, numerous variations are possible.

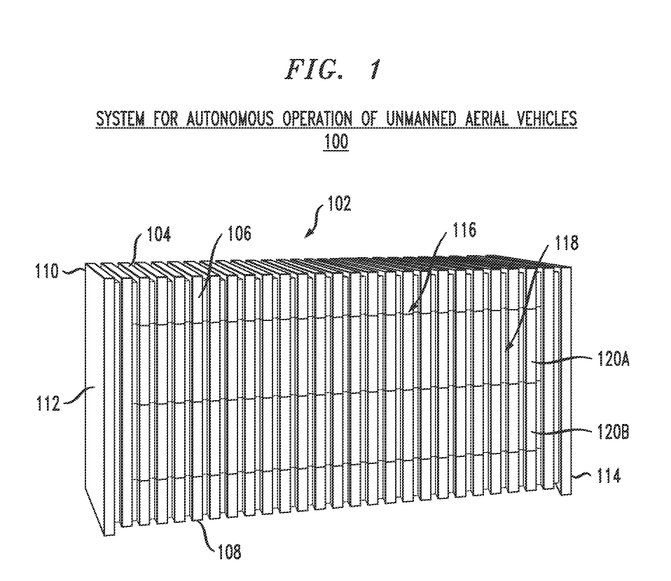

FIG. 1 depicts an exterior view of AUOS 100 in accordance with some embodiments of the present invention.

FIG. 1 shows container 102, which is defined by six sides 104-114 as follows: top side 104, front side 106, bottom side 108 (not visible in this Figure), back side 110 (not visible), left side 112, and right side 114 (not visible).

Container 102, which has the external appearance and dimensions of a twenty-foot intermodal container, houses other elements of AUOS 100 and the supported UAV(s) in accordance with the present invention. Although container 102 in the illustrative embodiment has the appearance of a twenty-foot intermodal container, it will be clear to those having ordinary skill in the art, after reading the present disclosure, that container 102 can be of any size, shape, appearance, and material that comports with the present invention. For example, in some embodiments, container 102 has the external appearance and dimensions of a “forty-foot” intermodal container, which is well-known in the art to be about twice as long as a twenty-foot intermodal container. In some other embodiments, container 102 has the external dimensions of a twenty-foot intermodal container, but a different appearance, as might be better suited to the specifics of those embodiments. In yet some further embodiments, another structure provides some or all of the functionality of container 102. For example, rather than being a stand-alone structure, the “container” is embodied, for example, as a building or a part of a ship.

Hatchway 116 is disposed in front side 106 of container 102. When open, the hatchway provides access to the interior of container 102. In particular, and as described more fully below, hatchway 116 enables a boom that is disposed within the container to deploy for UAV launch and recovery operations. Hatchway 116 is covered by hatch 118, implemented as doors 120A and 120B. In the illustrative embodiment, the doors are disposed one above the other, and each is coupled to the container along a horizontal edge of each door. The other horizontally oriented edge of each door is free to move, such that the doors open in the manner of opposing doors in a cabinet, except that here, each door rotates/pivots about a horizontal axis rather than a vertical axis as in the case of a conventional cabinet.

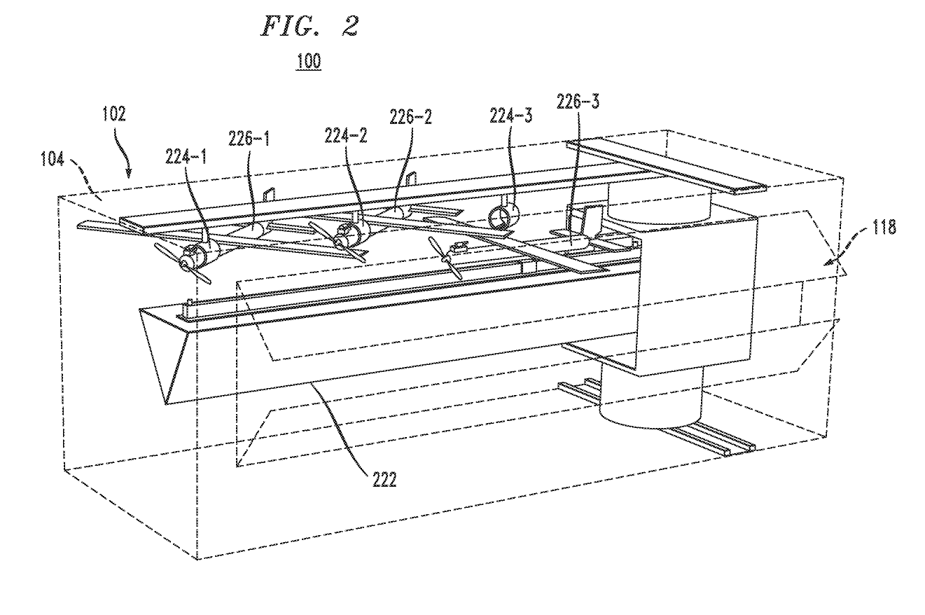

FIG. 2 depicts a ghosted view of AUOS 100, showing boom 222 and parking bays 224-1, 224-2, and 224-3 (generically and individually “parking bay 224-n,” collectively “parking bays 224”) within the interior of container 102. FIG. 2 depicts boom 222 of the AUOS 100 in a “stowed” position.

Parking bays 224 are located in the upper region of the interior of container 102 under top side 104. Each parking bay defines a region of container 102 that is intended to accommodate one UAV 226-n. FIG. 2 depicts UAVs parked in two of the parking bays (i.e., parking bays 224-1 and 224-2).

Each parking bay 224-n is suitably equipped to releasably engage a UAV. In the illustrative embodiment, this functionality is provided by a mechanical latch, which is coupled to the interior of container 102. The latch or other such mechanism provides AUOS 100 with an ability to securely “park” the UAVs.

In some embodiments, each parking bay 224-n includes equipment (not depicted) that extracts a parked UAV from the parking bay. Such equipment couples to the parked UAV and lowers it to a “pre-launch” position on boom 222. In some other embodiments, boom 222 itself, rather than parking bay 224-n, includes the equipment necessary for extracting a parked UAV from a parking bay and lowering it onto the boom. It is within the capabilities of those skilled in the art to specify, design, build, and operate the equipment used for extracting the UAV from the bay and lowering it onto boom 222.

In some embodiments, each parking bay 224-n comprises a device (not depicted) that lifts a UAV from boom 222 (i.e., after the UAV has completed its mission and has been recovered by the boom) and positions the UAV in a “mating” position for engagement by the mechanical latch, etc., for parking. In some embodiments, the device for lifting the UAV is an electro-mechanical linear actuator.

Container 102 is physically adapted to service UAVs that are parked therein. For example, in some embodiments, each parking bay 224-n has access to or otherwise includes a plurality of probes that provide:
electrical signals (e.g., programming, mission instructions, systems check-out, and/or diagnostics);
power; and/or
fuel for the UAVs.

Corresponding adaptations in the parked UAVs engage or otherwise couple to the probes. In some embodiments, the servicing provided by the probes is sufficient to fully prepare each UAV 226-n for launch. The probes, as well as power systems, communications gear, other electronics, fuel storage, conduits, devices, and connectors used for servicing and otherwise supporting UAVs are not depicted herein. It will be clear to those having ordinary skill in the art, after reading the present disclosure, how to implement these sub-systems for use in conjunction with the present invention.

Although FIG. 2 depicts three parking bays 224, it will be clear to those having ordinary skill in the art, after reading the present disclosure, how to make and use alternative embodiments of AUOS 100 that comprise fewer or more parking bays.

FIG. 2 depicts AUOS 100 in use with three UAVs: UAV 226-1, UAV 226-2, and UAV 226-3 (collectively “UAVs 226”). As previously indicated, UAVs 226-1 and 226-2 are parked and UAV 226-3 is engaged to boom 222. Although used in conjunction with AUOS 100, UAVs 226 are not, in fact, an element of AUOS 100.

In some embodiments, UAVs 226 are conventional unmanned aerial vehicles. In some other embodiments, UAVs 226 are enhanced or otherwise specially adapted for use with AUOS 100. For example, in some embodiments, one or more of UAVs 226 are enhanced in any one or more of the following ways:
to include communications devices for communicating with AUOS 100 or components thereof;
to include components that are specially adapted to launch from and be recovered by boom 222;
sized to be compatible with the interior capacity of container 102 or parking bays 224; and
equipped to be parked and serviced by components of AUOS 100.
   For some embodiments, the UAVs used with AUOS 100 will include both enhanced UAVs and conventional UAVs.

Although FIG. 2 depicts three UAVs 226 in AUOS 100, it will be clear to those having ordinary skill in the art, after reading the present disclosure, how to make and use alternative embodiments of AUOS 100 that receive and operate with fewer or more UAVs. Of course, for embodiments in which AUOS 100 operates with relatively more UAVs, the size of container 102 might be larger, such as the size of a forty-foot intermodal container.

FIG. 2 depicts boom 222 in a stowed position inside container 102. When the boom is stowed, hatch 118 can be closed, which effectively camouflages AUOS 100. In other words, the appearance of container 102 is that of an intermodal container. Furthermore, when boom 222 is in a stowed position, AUOS 100 can be readily transported. The operation of boom 222 is described in further detail below and in the accompanying figures.

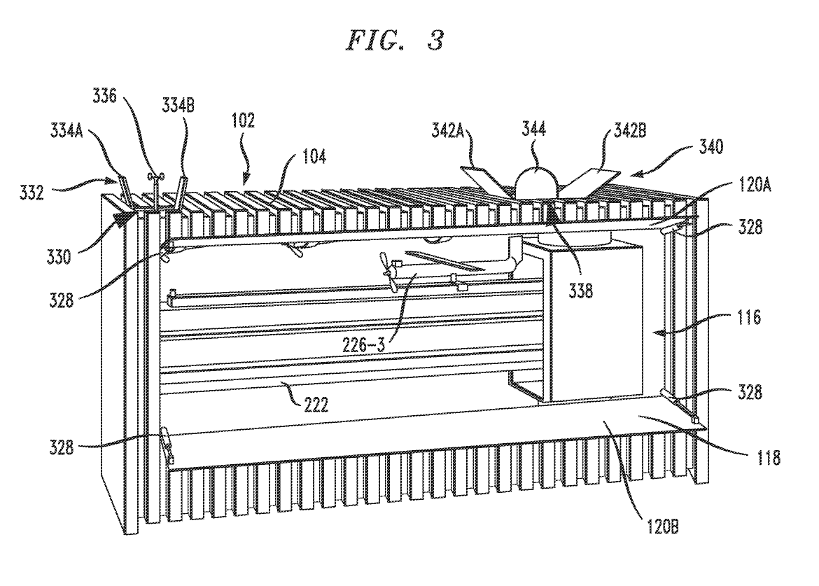

FIG. 3 depicts container 102 showing hatchways 116, 330, and 338 open so that equipment can be deployed from the interior of the container. FIG. 3 also depicts UAV 226-3 resting on boom 222.

As previously discussed, hatchway 116 provides ingress/egress for boom 222. Hatch 118 is automatically opened and closed to provide access to hatchway 116 via the operation of actuators 328, which couple doors 120A and 120B to container 102. Actuators 328 actuate responsive to commands issued by other components of AUOS 100 or by remote control from a remote station. In the illustrative embodiment, four pneumatically-driven actuators are used to operate hatch 118. It will be clear to those having ordinary skill in the art, after reading the present disclosure, how to make and use alternative embodiments in which actuators 328 are hydraulically or electrically driven, and/or are present in fewer or greater number.

Hatchway 330 is disposed in top side 104 of container 102. Hatchway 330 is covered by hatch 332, which is implemented as doors 334A and 334B. Actuators, not depicted, provide automatic opening and closing of hatch 332.

Hatchway 330 enables weather-sensing device 336 to deploy for access to the ambient environment for obtaining weather-related measurements (e.g., temperature, barometric pressure, wind direction and velocity, etc.). The weather-sensing device is actually a collection of conventional devices that are typically used for obtaining the aforementioned weather-related measurements. Readings from weather-sensing device 336 are communicated, via an appropriate interface/equipment, to other components of AUOS 100, a remote station, one or more of the supported UAVs 226, or a combination thereof.

Hatchway 338 is disposed in top side 104 of container 102. Hatchway 338 is covered by hatch 340, which is implemented as doors 342A and 342B. Actuators, not depicted, provide automatic opening and closing of hatch 340.

Hatchway 338 enables communications device 344 to deploy from the interior of container 102. Communications device 344 comprises antennas for receiving transmissions from or sending transmissions to, for example, a remote station or UAVs 226. Such transmissions can include launch or recovery orders intended for AUOS 100, status information concerning UAVs 226, or commands and status pertaining to other equipment within container 102.

Container 102 includes one or more mechanisms that deploy weather-sensing device 336 through hatchway 330 and communications device 344 through hatchway 338. In some embodiments, the mechanism(s) are electro-mechanical linear actuators.

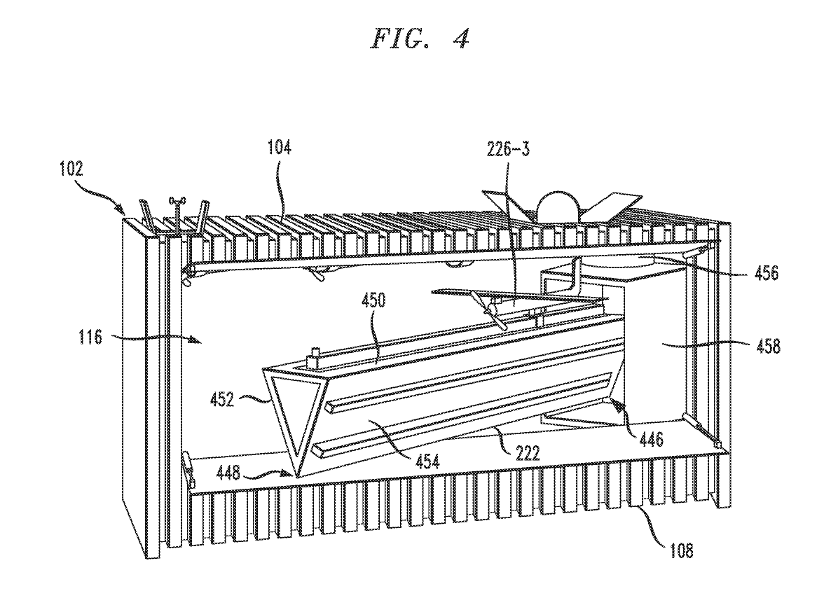

FIG. 4 depicts a free end of boom 222 being pivoted out of container 102 in preparation for launching UAV 226-3. Depicted in FIG. 4 are boom 222, fixed end 446 and free end 448 of boom 222, faces 450, 452, and 454 of boom 222, retaining column 456, and housing 458.

In some embodiments, retaining column 456 is rigidly coupled to the interior of container 102. In such embodiments, the retaining column is attached to either the inside surface of top side 104, the inside surface of bottom side 108, or both inside surfaces. Housing 458 is pivotably coupled to retaining column 456. The housing is pivotable about the longitudinal axis of retaining column 456, driven by a drive system (not depicted), such as a motor. Fixed end 446 of boom 222 is coupled to housing 458. As such, when housing 458 is pivoted about retaining column 456, boom 222 moves in concert.

In some other embodiments, retaining column 456 is pivotably coupled to the interior of container 102. A motor (not depicted) or other drive system drives the pivoting of the retaining column about its longitudinal axis. Housing 458 is rigidly coupled to retaining column 456. Fixed end 446 of boom 222 is coupled to housing 458. As such, when retaining column 456 is pivoted about its longitudinal axis, boom 222 moves as well.

In either of such scenarios (retaining column 456 pivoting or housing 458 pivoting), retaining column 456 acts as a pivot point about which boom 222 pivots. In this fashion, boom 222 is in effect pivotably coupled to the interior of container 102, which, when hatchway 116 is open, enables most of boom 222 to move out of container 102.

Although the illustrative embodiment of AUOS 100 includes container 102, it is to be understood that boom 222 can be used without container 102. In particular, and without limitation, in some alternative embodiments, retaining column 456 is coupled (pivotably or rigidly) to another structure, such as the deck of a ship, another fixed structure on board the ship, etc.

In the illustrative embodiment, boom 222 has a triangular cross section, providing the boom with three faces 450, 452, and 454. As depicted herein, these faces are flat surfaces disposed parallel to the longitudinal axis of boom 222.

Each face is equipped and physically adapted to carry out particular operations that are associated with that face. FIG. 4 depicts UAV 226-3 resting on face 450. In fact, face 450 serves as a launching platform. Accordingly, in preparation for launch, UAV 226-3 is disposed proximate to fixed end 446 of boom 222. Face 452 is associated with recovery of an airborne UAV and face 454 is associated with securing a recovered UAV to boom 222. The phrase “(a particular face of the boom) is associated with (a particular UAV-related operation),” as used herein and in the accompanying claims, is defined to mean that the identified operation is conducted at the specified face of the boom. Thus, the statement “a first face is associated with launching a UAV” means that the UAV is launched from the first face of the boom. In the illustrative embodiment, the particular face is uniquely associated with the particular operation. That is, the particular face is used to conduct that particular operation and no other operation, and no other face is used to conduct that particular operation. In some other embodiments, there is overlap between the functionality of the faces. Each face and its corresponding operation(s) are described in more detail below and in the accompanying figures.

To utilize a given face of boom 222 for its intended purpose, the face must be rotated into a proper “operational orientation.” This term is defined for use herein and in the accompanying claims to mean the orientation that the face must assume to conduct its associated operation. As discussed further below, the operational orientation is “up,” that is, facing the sky.

So, in addition to pivoting about retaining column 456, boom 222 rotates about its own longitudinal axis. For that purpose, boom 222 is rotatably coupled to housing 458. Rotation of the boom about its own longitudinal axis is driven by a motor, etc. (not depicted).

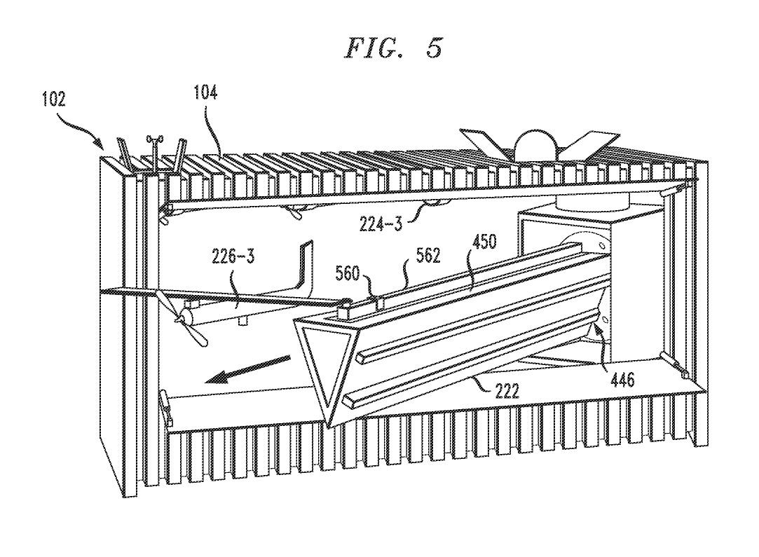

FIG. 5 depicts UAV 226-3 in flight immediately after launch from face 450 of boom 222. Face 450 is equipped to:

(i) receive UAV 226-n from a parking bay 224-n;

(ii) secure UAV 226-n while boom 222 pivots into launch position;

(iii) position UAV 226-n in preparation for launch;

(iv) enable, at least in part, the launching of UAV 226-n.

Item (i) was discussed briefly earlier in this specification. In further detail, to receive UAV 226-3, boom 222 rotates (while in container 102) about its longitudinal axis to orient face 450 upwards; that is, to a horizontal position that is parallel and opposed to the interior surface of top side 104 of container 102. When face 450 is horizontal and facing “up,” i.e., face 450 is in the operational orientation, UAV 226-3 can be lowered onto boom 222 from its respective parking bay.

To launch a UAV, boom 222 pivots about fixed end 446 into a proper direction for launch as shown by the directional arrow. Before the boom pivots, UAV 226-3 is secured to face 450, such as via a releasable coupling device embodied by coupling device 560 disposed on face 450.

Face 450 is further equipped with linear induction motor 562. The linear induction motor, which is familiar to those skilled in the art, is disposed on face 450 and aligned with the longitudinal axis of boom 222. When activated, linear induction motor 562 engages UAV 226-3 and accelerates it along face 450, launching the UAV clear of boom 222 in a direction of flight indicated by the directional arrow. In some embodiments, the UAV itself will supply at least some of the motive power required for launch, in addition to what boom 222 provides. After launch, the navigation path of the UAV is automatically controlled; in some embodiments control is via pre-programmed waypoints and in some other embodiments via a human operator at a remote station.

After launching UAV 226-3, boom 222 pivots about fixed end 446 to return to a stowed position in container 102. Boom 222 is then ready to receive another UAV from a parking bay. Alternatively, boom 222 proceeds to recovery operations of the launched UAV, which are described in more detail below and depicted in the accompanying figures.

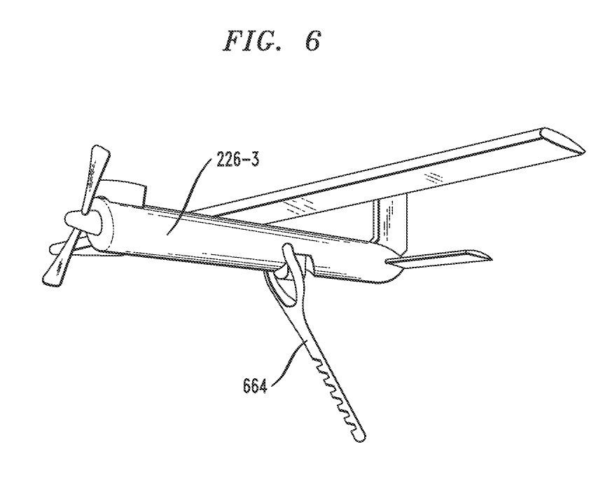

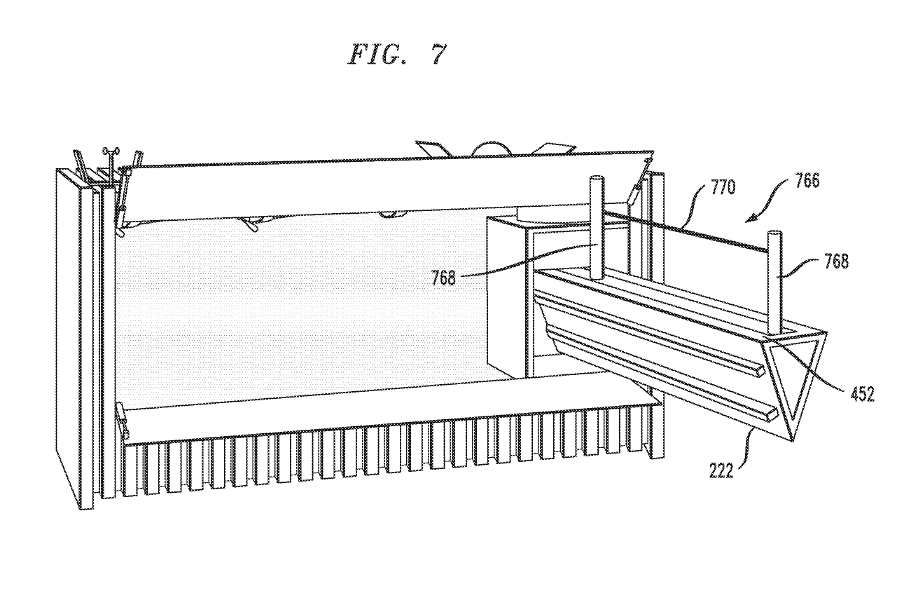

FIG. 6 depicts a view of unmanned aerial vehicle 226-3 in the air with hook 664 deployed. The hook is an arresting device that positively locks to an arresting cable (see FIG. 7, cable 770) as long as there is tension in the cable and weight on the hook. Hook 664 must be deployed to enable the snagging operation described in more detail below and in the accompanying figures. In some embodiments, the UAV deploys hook 664. In some embodiments, this is done autonomously; in some other embodiments, deployment is in response to a command from AUOS 100 or from a remote station.

During UAV recovery to the platform that supports AUOS 100, e.g., a ship, a differential GPS-based control system that controls the UAV's flight control system provides the navigation path and approach glide slope of the UAV. Such control systems are commercially available and well known in the art. This control system requires no human intervention and communicates to the UAV via a radio frequency link system located in AUOS 100.

FIG. 7 depicts a view of boom 222 in a recovery position with face 452 operationally oriented for snagging a UAV via recovery system 766.

To snag UAV 226-3 from the air, boom 222 takes a position in a proper direction for recovery. To do so, boom 222 pivots about its fixed end. Furthermore, boom 222 rotates about its longitudinal axis to orient face 452 upwards, i.e., face 452 is in the operational orientation.

Face 452 is equipped with recovery system 766, which comprises deployable upright supports 768 and cable 770 that couples to the upright supports. Supports 768 are pivotably coupled to face 452 so that when face 452 is not in the operational orientation (i.e., not facing “up”), the supports collapse onto face 452. In some alternative embodiments, supports 768 stow within cavities in the boom that are accessible via face 452. When recovery system 766 is activated, supports 768 deploy to an upright position pulling cable 770 taut and supporting it in the air.

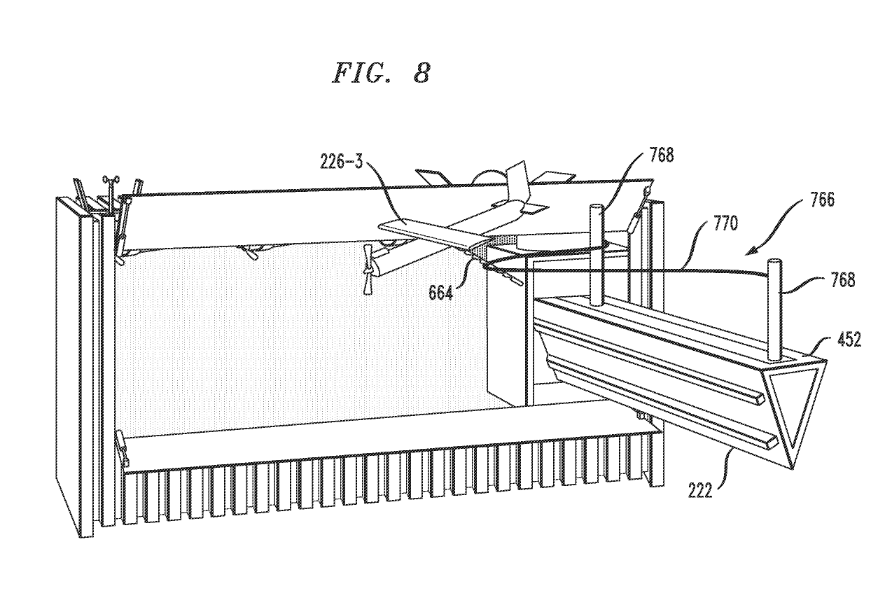

FIG. 8 depicts cable 770 of recovery system 766 snagging UAV 226-3.

Hook 664 is designed to snag to an arresting cable, such as cable 770, when the UAV flies over the cable. When cable 770 snags hook 664, boom 222 maintains face 452 in the operational orientation, i.e., facing “up.”

When hook 664 snags to cable 770, the cable extends (compare FIGS. 7 and 8) and a braking sub-system (not depicted) that is coupled to the cable activates. Spring dampers in upright supports 768 and a magnetic fluid braking system regulate the tension in cable 770 to compensate for variations in UAV weights, the speed of the platform that supports AUOS 100, and the natural wind passing over boom 222. See, e.g., U.S. Pat. No. 7,219,856 B2, which is incorporated by reference in its entirety herein. It will be clear to those having ordinary skill in the art, after reading the present disclosure, how to make and use alternative embodiments that implement cable 770 or recovery system 766 differently.

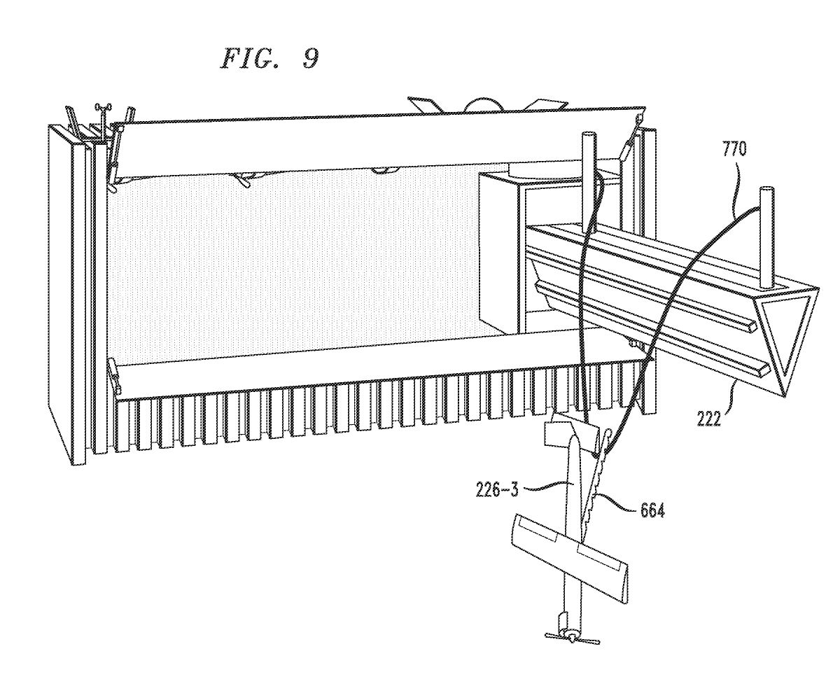

FIG. 9 depicts UAV 226-3 fully arrested and snagged to cable 770. As depicted in this Figure, UAV 226-3 hangs from cable 770 below boom 222. Hook 664 is positively locked to cable 770, because there is weight on hook 664 and tension in cable 770.

After the UAV is arrested, cable 770 is retracted via an associated capture mechanism (not shown). As cable 770 retracts, the cable and the UAV are drawn towards boom 222.

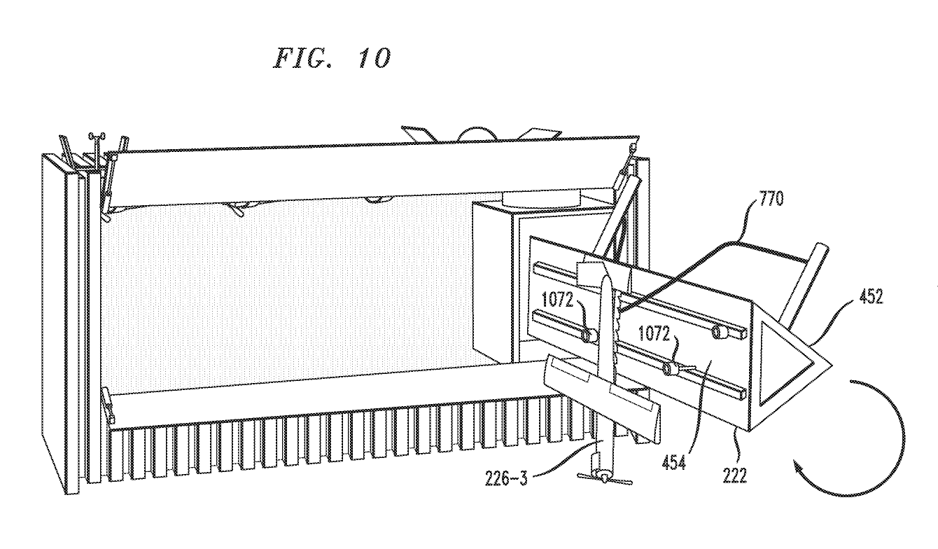

FIG. 10 depicts boom 222 rotating about its longitudinal axis, rotating face 452 out of the operational orientation as it rotates face 454 towards the operational orientation.

Face 454 is associated with securing a recovered UAV to the boom. As cable 770 retracts and UAV 226-3 is pulled toward boom 222, components on face 454 are activated to move the UAV to a predetermined position on the boom. Positioning clamps 1072, which are disposed on face 454, begin to close towards UAV 226-3.

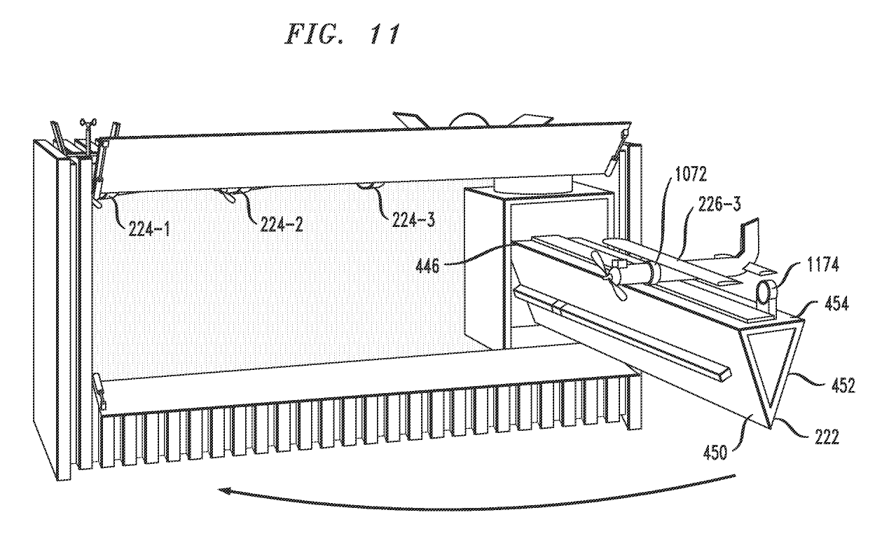

FIG. 11 depicts boom 222 with UAV 226-3 secured to face 454.

To continue the securing operation that is associated with face 454, boom 222 continues to rotate until face 454 is in the operational orientation, i.e., facing “up.”

Positioning clamps 1072 on face 454 close on the fuselage of UAV 226-3. The closure is releasable. In the illustrative embodiment, positioning clamps 1072 close on the fuselage forward of the UAV's wings.

Face 454 also comprises clamps 1174 which close on the fuselage of UAV 226-3. The closure is releasable, and releases when the UAV is to be lifted into a parking bay, such as parking bay 224-3. In the illustrative embodiment, clamps 1174 close on the fuselage aft of the UAV's wings. It will be clear to those having ordinary skill in the art, after reading the present disclosure, how to make and use alternative embodiments in which face 454 is equipped with different mechanisms that secure a UAV to boom 222.

After face 454 establishes positive control over UAV 226-3 by securing it to boom 222, the tension in cable 770 is released and the cable drops from hook 664. Supports 768 stow away and cable 770 is fully retracted.

Boom 222 pivots about fixed end 446 to return to a stowed position, as indicated by the directional arrow. When stowed, boom 222 enables UAV 226-3 to be parked in parking bay 224-3.

In the illustrative embodiment, face 454 comprises additional components (not shown) that enable a UAV to be re-positioned such that its fuselage is parallel to the longitudinal axis of boom 222. Positioning clamps 1072 release the fuselage of the UAV. A linear induction motor (not shown), which is longitudinally disposed on face 454, moves the UAV along face 454 to align it to a proper position beneath a selected parking bay 224-n. From this position, the UAV can be securely parked in the parking bay, wherein the UAV can be serviced and readied for another launch. After UAV 226-3 is removed from boom 222, the boom can proceed to another launch or recovery operation.

In some embodiments, the boom only uses two faces; face 450 for launching a UAV and face 452 for snagging a UAV from the air. Although such embodiments require human intervention, they reduce the complexity of AUOS 100.

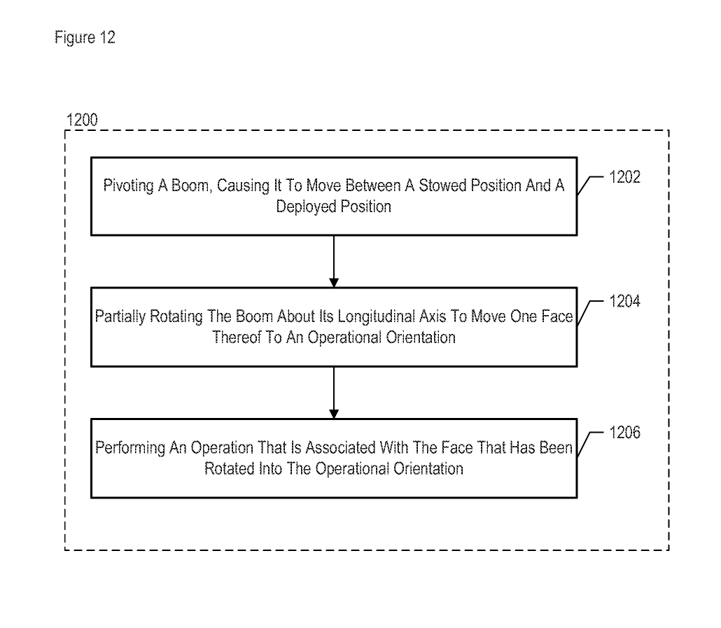

METHODS. FIG. 12 presents method 1200 in accordance with the illustrative embodiment of the present invention. This method recites the operations that are basic to launching, recovering, securing, parking, and servicing one or more UAVs without human intervention at the site of AUOS 100 as previously discussed.

Referring now to method 1200, operation 1202 recites pivoting a boom, e.g., boom 222, about its fixed end, causing the boom to move between a stowed position and a deployed position. As previously discussed, when the boom is in the deployed position, it is capable of launching or recovering a UAV.

At operation 1204, the boom partially rotates about its longitudinal axis to move one face of a plurality thereof into an operational orientation. The operational orientation enables the respective face to perform the associated operation(s) of the boom. As previously indicated, the operational orientation is when the face is facing “up.”

As previously discussed, in the illustrative embodiment, the boom has three faces, each uniquely associated with a different aspect of the operational cycle of AUOS 100. In particular, a first face is associated with launching a UAV, a second face is associated with arresting flight of a UAV, and a third face is associated with securing the UAV to the boom after it has been snagged.

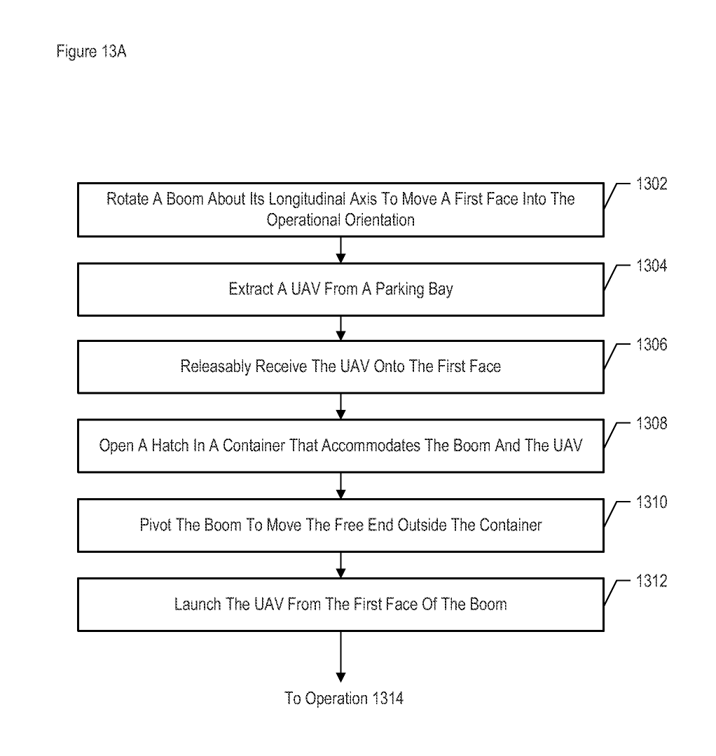

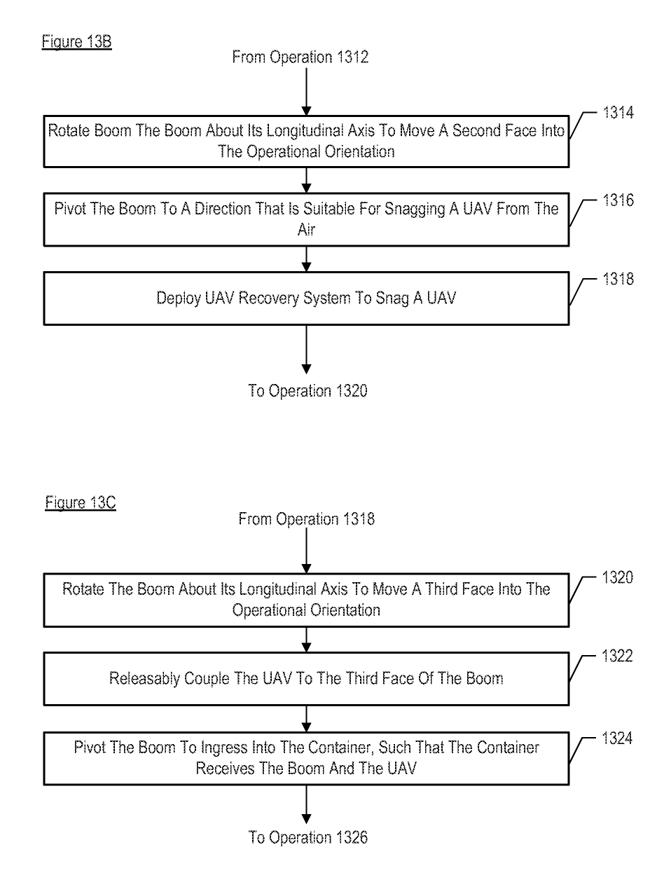

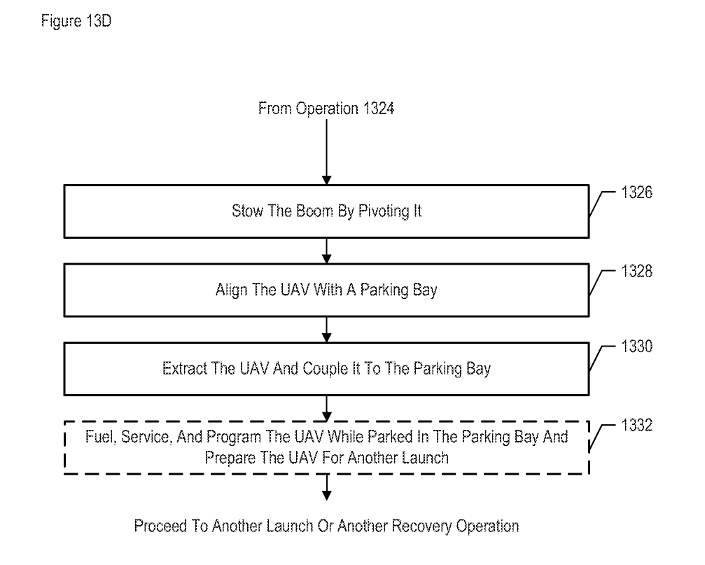

FIGS. 13A through 13D depict the complete operational cycle of AUOS 100 relative to a UAV (i.e., launch, recovery, and preparation for a next launch). As such, the various steps depicted in these Figures are to be considered sub-operations of the various operations of method 1200.

FIG. 13A depicts operations 1302 through 1312. These sub-operations of method 1200 are associated with launching a UAV from a boom and, as such, collectively define a method of a launching a UAV.

Operation 1302 recites partially rotating a boom about its longitudinal axis to move a first face (e.g., face 450) into the operational orientation.

At operation 1304, a UAV is extracted from a parking bay, e.g., parking bay 224-n.

At operation 1306, the first face of the boom releasably receives the extracted UAV.

Operation 1308 recites opening a hatch in the container, e.g., container 102, which contains both the boom and the UAV.

At operation 1310, the boom pivots about its fixed end to move its free end through the open hatch to the outside of the container to a position that is suitable for conducting the first operation, i.e., launching the UAV.

At operation 1312, the UAV is launched from the first face of the boom.

It is notable that in conducting sub-operations 1302 through 1312, the order of operations 1202 and 1204 of method 1200 is “reversed.” That is, although method 1200 recites “pivoting a boom” (1202) before “partially rotating the boom” (1204), sub-operation 1302 partially rotates the boom before the boom is pivoted in sub-operation 1310. The order in which the boom is pivoted and partially rotated depends upon which particular operation (e.g., launch, recovery, etc.) is being performed. In fact, for some operations, the order is not important. It is to be understood, therefore, that the order of the operations of method 1200 is freely permutable as is required or desired for the particular operation that is being performed via the method.

FIG. 13B depicts operations 1314 through 1318. These sub-operations of method 1200 are associated with recovering a UAV from flight and, as such, collectively define a method of recovering a UAV.

Operation 1314 recites rotating the boom about its longitudinal axis to move a second face (e.g., face 452) into the operational orientation.

Operation 1316 recites pivoting the boom to a position that is suitable for conducting the second operation (i.e., recovering the UAV). In some embodiments, the free end of the boom will be pivoted back into the container after launching a UAV. In such embodiments, the boom must be deployed (from within the container) in operation 1316. In some other embodiments, the boom will remain deployed after launch of a first UAV, such as when a second UAV is to be recovered immediately after launch of the first UAV. In such situations, it might be desirable to maintain the boom in a deployed position after launch rather than returning it to the container. In these embodiments, operation 1316 will simply involve pivoting the already deployed boom from the launch position to a position that is more suitable for UAV recovery.

Operation 1318 recites deploying a UAV recovery system (e.g., recovery system 766). In the illustrative embodiment, the UAV recovery system, which includes supports (e.g., supports 768) and an arresting cable (e.g., cable 770), deploys from the second face of the boom. In the illustrative embodiment, the supports are pivotably coupled to the second face of the boom. Upon deployment of the recovery system, the supports are pivoted to a position that is approximately orthogonal to the second face. The arresting cable is held taut between the two supports. The UAV is then flown so that a hook, etc., snags the arresting cable.

It is to be understood that for recovery operations 1314 through 1318, either the boom can be pivoted and then partially rotated, or it can be partially rotated and then pivoted. Either order is acceptable.

FIG. 13C depicts operations 1320 through 1324. These sub-operations of method 1200 are associated with securing a snagged UAV to the boom and returning it to the container.

Operation 1320 recites partially rotating the boom about its longitudinal axis to move a third face of the boom (e.g., face 454) into the operational orientation. This operation (in conjunction with retracting the arresting cable) draws the snagged UAV to the third face of the boom.

At operation 1322, the UAV is releasably coupled to the third face. This secures the recovered UAV to the boom.

Operation 1324 recites pivoting the boom about its fixed end to move the free end of the boom and the secured UAV into the container.

FIG. 13D depicts operations 1326 through 1332. These sub-operations of method 1200 are associated with parking the recovered UAV and include the optional sub-operation of servicing the recovered UAV.

Operation 1326 recites stowing the boom by pivoting it about its fixed end such that the free end and the coupled UAV return to the container.

Operation 1328 recites aligning the UAV with a parking bay (e.g., bay 224-n) for which it is destined. In some embodiments, this involves moving (via a suitable mechanism) the UAV along the third face of the boom to position the UAV beneath a parking bay of interest. In other embodiments, the UAV can simply be retrieved and then shuttled (e.g, via an overhead crane, etc.) to an available parking bay.

Operation 1330 recites extracting the UAV (e.g., from the third face) and releasably coupling it to a parking bay as previously described.

As desired, the parked UAV can serviced, as recited in optional operation 1332. In embodiments in which the container includes the requisite equipment, this operation can be executed autonomously. In embodiments in which the container is not equipped for autonomous servicing, the UAVs are manually serviced or via remote control.

In some embodiments, upon completion of operation 1330, the system is ready to conduct another launch or recovery operation. In some embodiments, these operations can be conducted while a UAV is being serviced (optional operation 1332); in some other embodiments, launch or recovery is conducted after servicing operations are complete.

It is to be understood that the present disclosure teaches just some illustrative embodiments and that many variations of the invention can easily be devised by those skilled in the art after reading this disclosure, and that the scope of the present invention is to be determined by the following claims.

What is claimed is:

1. A system for launching and recovering an unmanned aerial vehicle, the system comprising:
a boom having a first end and a second end, wherein:
the boom comprises a plurality of faces, each face being disposed parallel to a longitudinal axis of the boom, and
the boom is operable to rotate about the longitudinal axis thereof to orient each face to an operational orientation in accordance with a corresponding operation of the boom, and wherein the operation comprises at least one of launching, snagging, and securing the unmanned aerial vehicle.

2. The system of claim 1 wherein:
a first face of the plurality of faces comprises a first physical adaptation for launching the unmanned aerial vehicle, and
a second face of the plurality of faces comprises a second physical adaptation for snagging the unmanned aerial vehicle from the air, and
a third face of the plurality of faces comprises a third physical adaptation for securing the unmanned aerial vehicle to the boom.

3. The system of claim 2 wherein the boom is further operable to pivot about the first end.

4. The system of claim 1 wherein a first face of the plurality of faces comprises a first physical adaptation for launching the unmanned aerial vehicle, and
wherein the first physical adaptation comprises a first linear induction motor that is operable, when the first face is in the operational orientation, to (i) releasably couple to and (ii) at least in part enable the launching of the unmanned aerial vehicle.

5. The system of claim 1 wherein a second face of the plurality of faces comprises a second physical adaptation for snagging the unmanned aerial vehicle, and
wherein the second physical adaptation comprises:
a cable that is coupled to two supports, each support being pivotably coupled to the second face for deploying the cable when the second face is in the operational orientation, wherein the deployed cable is supported in air by the two supports.

6. The system of claim 1 wherein a third face of the plurality of faces comprises a third physical adaptation for securing the unmanned aerial vehicle to the boom, and
wherein the third physical adaptation comprises:
a second linear induction motor, and
a clamping device that is disposed on the third face for releasably coupling the unmanned aerial vehicle to the third face when the third face is in the operational orientation.

7. The system of claim 1 further comprising a container, wherein:
the first end of the boom is pivotably coupled to the interior of the container, and
the container is dimensioned and arranged to receive the boom and the unmanned aerial vehicle, and
the container comprises a hatchway that is dimensioned and arranged to enable the second end of the boom and the unmanned aerial vehicle to egress from and ingress into the container.

8. The system of claim 7 wherein the exterior of the container has the dimensions of a twenty-foot intermodal container.

9. The system of claim 7 wherein the exterior of the container emulates the appearance and dimensions of a twenty-foot intermodal container.

10. The system of claim 7 wherein the unmanned aerial vehicle is one of a plurality of unmanned aerial vehicles, and wherein the container is arranged and dimensioned to receive the plurality of unmanned aerial vehicles.

11. The system of claim 1 wherein the system comprises at least one physical adaptation for enabling at least one of (i) autonomous launching and (ii) autonomous recovering of the unmanned aerial vehicle by the system.

12. A system for launching and recovering an unmanned aerial vehicle, the system comprising:
a boom having a first end and a second end, wherein:
the boom comprises a plurality of faces, each face being disposed parallel to a longitudinal axis of the boom, and
the boom is operable to rotate about the longitudinal axis thereof; and
a container that is dimensioned and arranged to receive the boom and the unmanned aerial vehicle, wherein:
the first end of the boom is pivotably coupled to the interior of the container, and
the boom is operable to pivot about the first end, and
the container comprises a hatchway that is dimensioned and arranged to enable the second end of the boom and the unmanned aerial vehicle to egress from and ingress into the container.

13. The system of claim 12 wherein:
a first face of the boom comprises a first physical adaptation for launching the unmanned aerial vehicle, and
a second face of the boom comprises a second physical adaptation for snagging the unmanned aerial vehicle from the air, and
a third face of the boom comprises a third physical adaptation for securing the unmanned aerial vehicle to the boom.

14. The system of claim 13 wherein the first physical adaptation comprises a first linear induction motor that is operable, when the first face is in an associated operational orientation, to (i) releasably couple to and (ii) at least in part enable a launch of the unmanned aerial vehicle.

15. The system of claim 13 wherein the second physical adaptation comprises:
a cable that is coupled to two supports, each support being pivotably coupled to the second face for deployment of the cable when the second face is in an associated operational orientation, wherein the deployed cable is supported in air by the two upright supports.

16. The system of claim 13 wherein the third physical adaptation comprises:
a second linear induction motor, and
a clamping device that is disposed on the third face for releasably coupling the unmanned aerial vehicle to the third face when the third face is in an associated operational orientation.

17. The system of claim 12 wherein a structure that is static comprises the container.

18. The system of claim 12 wherein a vehicle comprises the container.

19. The system of claim 12 wherein the exterior of the container has the dimensions of a twenty-foot intermodal container.

20. The system of claim 12 wherein the exterior of the container emulates the appearance and dimensions of a twenty-foot intermodal container.

21. The system of claim 12 wherein the unmanned aerial vehicle is one of a plurality of unmanned aerial vehicles, and wherein the container is dimensioned and arranged to receive the plurality of unmanned aerial vehicles.

22. The system of claim 12 further comprising:
at least one of (i) a first device that is adapted for electronic communications, and (ii) a second device that is adapted for sensing weather, wherein the container is further dimensioned and arranged to receive the first device and the second device.

23. The system of claim 22 wherein the container comprises at least one physical adaptation for exposing to the atmosphere at least one of the first device and the second device.

24. The system of claim 22 wherein the system comprises a physical adaptation for enabling the system to perform at least one of (i) launching and (ii) recovering the unmanned aerial vehicle, by control from a station that is remote from the container, and wherein the first device comprises a further physical adaptation for communicating with the station.

25. A method for use with an unmanned aerial vehicle, the method comprising:
pivoting a boom about a first end thereof, causing the boom to move between a stowed position and a deployed position, wherein in the deployed position, the boom performs at least two operations related to the unmanned aerial vehicle;
partially rotating the boom about a longitudinal axis thereof to move one face of a plurality of faces of the boom to an operational orientation, wherein one operation of the at least two operations is performed when the one face is in the operational orientation; and
conducting the one operation.

26. The method of claim 25 wherein the plurality of faces comprises:
a first face that is associated with a first one of the at least two operations;
a second face that is associated with a second one of the at least two operations; and
a third face that is associated with a third one of the at least two operations.

27. The method of claim 26 wherein the first operation comprises launching the unmanned aerial vehicle.

28. The method of claim 26 wherein the second operation comprises arresting flight of the unmanned aerial vehicle.

29. The method of claim 26 wherein the third operation comprises securing the unmanned aerial vehicle to the boom after flight of the unmanned aerial vehicle has been arrested.

30. The method of claim 26 wherein the operation of partially rotating the boom further comprises partially rotating the boom, prior to pivoting the boom, to move the third face out of the operational orientation and to move the first face into the operational orientation, wherein the first face receives the unmanned aerial vehicle for launch.

31. The method of claim 30 further comprising launching the unmanned aerial vehicle from the first face.

32. The method of claim 28 wherein the operation of partially rotating the boom further comprises partially rotating the boom to move the first face out of the operational orientation and move the second face into the operational orientation.

33. The method of claim 32 further comprising pivoting the boom about the first end thereof to move the boom to a stowed position prior to partially rotating the boom to move the second face into the operational orientation.

34. The method of claim 33 further comprising pivoting the boom about its first end to move to the deployed position after partially rotating the boom to move the second face into the operational orientation.

35. The method of claim 32 further comprising deploying a recovery system from the second face, wherein the recovery system arrests the flight of the unmanned aerial vehicle.

36. The method of claim 29 wherein the operation of partially rotating the boom further comprises partially rotating the boom to move the second face out of the operational orientation and move the third face into the operational orientation.

37. The method of claim 36 further comprising drawing the unmanned aerial vehicle toward the third face.

38. The method of claim 37 further comprising securing the unmanned aerial vehicle to the third face.

39. The method of claim 38 further comprising pivoting the boom about the first end thereof after securing the unmanned aerial vehicle to the third face of the boom.
